(19) United States
(12) Patent Application Publication
(10) Pub. No.: US 2026/0197742 A1
(43) Pub. Date: Jul. 9, 2026

(54) ROUTING COLLABORATION USING MOBILE AD-HOC NETWORKS

(71) Applicant: Telefonaktiebolaget LM Ericsson (publ), Stockholm (SE)

(72) Inventors: Rodrigo ALVAREZ DOMINGUEZ, Madrid (ES); Miguel Angel MUÑOZ DE LA TORRE ALONSO, Madrid (ES)

(21) Appl. No.: 19/133,287

(22) PCT Filed: Dec. 29, 2022
(86) PCT No.: PCT/EP2022/088008

§ 371 Date: May 28, 2025

(30) Foreign Application Priority Data
Nov. 29, 2022 (EP) 22383147.0

(51) Int. Cl. H04W 40/02; H04W 84/18

(52) U.S. Cl. CPC H04W 40/02; H04W 84/18

(57) ABSTRACT

A method (300) performed by a first network function for Mobile Ad-Hoc Networks, MANET, routing. The method includes receiving, from a second NF, a first MANET related notification message, wherein the first MANET related notification message comprises information indicating that a first User Equipment, UE, 111 and a second UE 112 have activated MANET routing, and the second UE 112 has been selected to be MANET router for the first UE 111. The method also includes sending (s302) traffic towards the first UE 111, via the second UE 112 using MANET; or receiving (S302) traffic from the first UE 111 via the second UE 112 using MANET, wherein the first UE 111 lost cellular communication coverage and the second UE 112 has cellular communication coverage, and the second UE 112 is being as MANET router for the first UE 111 and the second UE 112 has MANET coverage to the first UE 111. (FIG. 3)

### TECHNICAL FIELD

Disclosed are embodiments related to Routing collaboration using Mobile Ad-Hoc Networks.

### BACKGROUND

In 5th Generation (5G) cellular networks, a service-based architecture is used for the 5G core (5GC) network, which is broken down into communicating services known as Network Functions (NFs). FIG. 1 illustrates a 5G system reference architecture 100 showing service-based interfaces used within the Control Plane (CP). It will be appreciated that not all NFs are depicted. Service-based interfaces are represented in the format Nxyz and point to point interfaces in the format Nx. The reference architecture 100 comprises a Unified Data Repository, UDR 101 that has a Nudr interface, a Network Exposure Function (NEF) 102 that has a Nnef interface, a Network Data Analytics Function, NWDAF 103 that has a Nnwdaf interface, an Application Function (AF) 104 that has a Naf interface, a Policy Control Function (PCF) 105 that has a Npcf interface, a Charging Function (CHF) 106 that has a Nchf interface, an Network Repository Function (NRF) 107 that has a Nnrf interface, an Access and Mobility Management Function (AMF) 108 that has a Namf interface, a Session Management Function (SMF) 109 that has a Nsmf interface, and the SMF 109 has an N4 interface to a User Plane Function (UPF) 110.

The relevant architectural aspects for the present disclosure are the AMF 108, the UDR or Unified Data Management (UDM) 101, the PCF 105 and the AF 104.

The AF 104 interacts with the 3GPP Core Network; the NEF 102 supports different Exposure APIs; NWDAF 103 represents operator managed network analytics logical function; UDR 101 stores data grouped into distinct collections of subscription-related information, i.e., Subscription Data, Policy Data, Structured Data for Exposure, and Application Data; the PCF 105 supports a unified policy framework to govern the network behavior. Specifically, the PCF 105 provides PCC (Policy and Charging Control) rules to the PCEF (Policy and Charging Enforcement Function), i.e., the SMF/UPF that enforces policy and charging decisions according to provisioned PCC rules; the SMF 109 supports different functionalities, e.g., SMF receives PCC rules from the PCF and configures the UPF accordingly; UPF 110 supports handling of user plane traffic based on the rules received from the SMF, e.g. packet inspection and different enforcement actions such as QoS handling; NRF 107 supports the functionalities, for example, Maintains the NF profile of available NF instances and their supported services, the Third Generation Partnership Project (3GPP) Technical Standard (TS) 29.510 v17.6.0 gives more specific description for the architecture.

Mobile Ad-hoc Network (MANET) is a collection of mobile nodes that act as both routers and hosts in an ad-hoc wireless network and that dynamically self-organize in a wireless network without using any pre-established infrastructure. Nodes typically transmit in broadcast messages that reach only nearby nodes. There are different types of MANET, below are some of them,
Flying Ad Hoc Network (FANET) is a subclass of MANET. Its architecture consists of swarm of small flying vehicles such as unmanned aerial vehicles (UAVs) and Ground Control Station;
Vehicular Ad hoc Networks (VANETs) enable effective communication with another vehicle or with the roadside equipments. Intelligent vehicular ad hoc networks (InVANETs) deals with another vehicle or with the roadside equipment.

There are three broad categories of mobile ad hoc network routing protocols namely: proactive, reactive, and hybrid protocols.
Proactive: Nodes have a table with paths to all destinations. Better Approach To Mobile Adhoc Networking (BATMAN) is one example of proactive protocol. Other protocols in this category are:
   DSDV: Destination Sequenced Distance Vector,
   OLSR: Optimized Link State Routing
   BABEL: RFC 6126—The Babel Routing Protocol (ietf.org)
Reactive: Each node only calculates one path to a destination when you need it to send a message. DSR: Dynamic Source Routing is an example of reactive protocol. Other examples are:
   AODV: Ad-hoc On-demand Distance Vector
   TORA: Temporally Ordered Routing Algorithm
Hybrid: Divide the network into zones, for the most nearby build routes proactively, for nodes further away reactively. OORP: Order One Routing Protocol is one example of hybrid protocol. ZRP (Zone Routing Protocol) is another example.

BATMAN is a proactive routing protocol for Wireless Ad-hoc Mesh Networks, including (but not limited to) MANETs. The protocol proactively maintains information about the existence of all nodes in the mesh that are accessible via single-hop or multi-hop communication links. The strategy of BATMAN is to determine for each destination in the mesh one single-hop neighbor, which can be utilized as best gateway to communicate with the destination node. BATMAN detects the presence of BATMAN-Originators, no matter whether the communication path to/from an Originator a single-hop or multi-hop communication link is. The protocol does not try to find out the full routing path, instead it only learns which link-local neighbor is the best gateway to each Originator.

### SUMMARY

Certain challenges presently exist when a terminal device loses cellular coverage but needs connection. For example, in industrial environment such as in a mine, a miner or a sensor loses its cellular coverage and connection is needed, or an Unmanned Aerial Vehicle, UAV, connects using 5G connection loses the cellular coverage and the connection is needed. This present disclosure provides a way for installing ad-hoc networks for the terminal device(s)/User Equipment(s) (UEs) without cellular coverage.

Accordingly, in the first aspect there is provided a method performed by a first network function (e.g., AF 104). In one embodiment, the method for MANET routing include that the first network function receives from a second NF (e.g., PCF 105) a first MANET related notification message which comprises information indicating that a first User Equipment (UE) 111 and a second UE 112 have activated MANET routing, and the second UE 112 has been selected to be MANET router for the first UE 111. The method also includes that the first NF sends traffic towards the first UE 111 via the second UE 112 using MANET; or receiving traffic from the first UE 111 via the second UE (112) using MANET, wherein the first UE 111 loses cellular communication coverage, the second UE 112 has cellular communication coverage, the second UE 112 is acting as MANET router for the first UE 111, and the second UE (112) has MANET coverage to the first UE 111.

In the second aspect there is provided a method performed by a second network function (e.g., Policy Control Function, PCF 105). In one embodiment, the method for MANET routing includes that the first NF receives from the third NF (i.e., AMF 108) a first MANET related report message which comprises radio condition information (i.e., Received Signal Strength Indicator, RSSI) indicating a first UE, is in low radio condition. The method also includes that the second NF selects, based on a MANET routing policy, a second UE from a plurality of UEs as a MANET router UE for the first UE, wherein the plurality of UEs have activated MANET process, and the second UE is in good radio condition or medium radio condition, and the second UE has MANET coverage to the first UE. The method also includes sending, towards the second UE, a first MANET related request message which comprises information (i.e., MANET routing) indicating the second UE being as MANET router for the first UE. The method also includes sending to the first NF a first MANET notification message which comprises information indicating at least one of: the first UE and the second UE have activated MANET routing, and the second UE is a MANET router UE for the first UE.

In the third aspect there is provided a method performed by a third network function (e.g., AMF 108). In one embodiment, the method for MANET routing includes that the third NF receives from a plurality of UEs, MANET related report messages, wherein each of the MANET related report messages comprises radio condition information related to each UE of the plurality UEs. The method also includes sending the radio information towards a second NF.

In the fourth aspect there is provided a method performed by a first UE 111. In one embodiment, the method for MANET routing includes that the first UE sends traffic towards a first NF via a second UE using MANET or receiving traffic from the first NF via the second UE using MANET, wherein the first UE loses cellular communication coverage, the second UE has cellular communication coverage, the second UE is being as MANET router for the first UE, and the second UE has MANET coverage to the first UE.

In the fifth aspect there is provided a method performed by a second UE. In one embodiment, the method for MANET routing includes that the second UE is acting as a MANET router for a first UE. The method also includes that the second UE receives traffic from a first UE using MANET and transmits the traffic towards a first NF; or, receives traffic from the first NF, and transmits the traffic towards the first UE using MANET; wherein the first UE loses cellular communication coverage, the second UE has cellular communication coverage, and the second UE has MANET coverage to the first UE.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium.

In another aspect there is provided a network node that is configured to perform the methods disclosed herein. In some embodiments, the network node comprises a data storage system and processing circuitry coupled to the data storage system, wherein the network node is configured to perform the methods disclosed herein.

In another aspect there is provided a terminal device that is configured to perform the methods disclosed herein. In some embodiments, the terminal device comprises a data storage system and processing circuitry coupled to the data storage system, wherein the terminal device is configured to perform the methods disclosed herein.

An advantage of at least some of the embodiments disclosed herein is that they provide a mechanism to route traffic towards ad-hoc networks when one of the terminal devices lose its cellular coverage.

### BRIEF DESCRIPTION OF THE DRAWINGS

The accompanying drawings, which are incorporated herein and form part of the specification, illustrate various embodiments.

FIG. 1 is a diagram illustrating the 5G architecture reference.

FIG. 2 is a message flow diagram illustrating routing collaboration using MANET.

FIG. 3 is a flowchart illustrating a process according to some embodiments.

FIG. 4 is a flowchart illustrating a process according to some embodiments.

FIG. 5 is a flowchart illustrating a process according to some embodiments.

FIG. 6 is a flowchart illustrating a process according to some embodiments.

FIG. 7 is a flowchart illustrating a process according to some embodiments.

FIG. 8 is a block diagram of a network node according to some embodiments.

FIG. 9 is a block diagram illustrating a virtualization environment in which functions implemented by some embodiments may be virtualized.

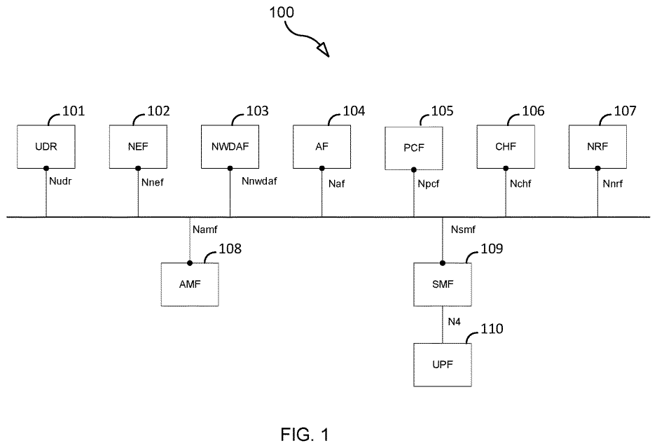

### DETAILED DESCRIPTION

As noted above, a solution is needed to support a mechanism to route traffic towards ad-hoc networks when one of the devices loses its cellular coverage.

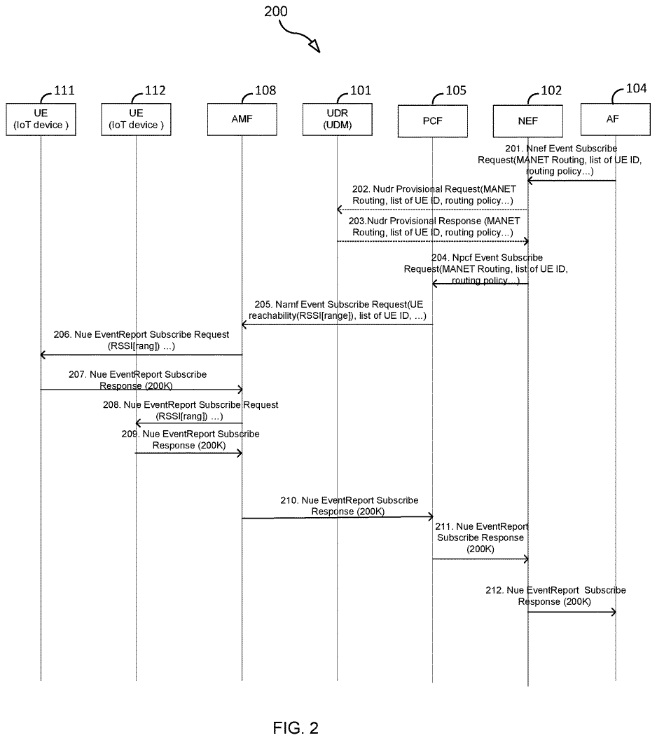

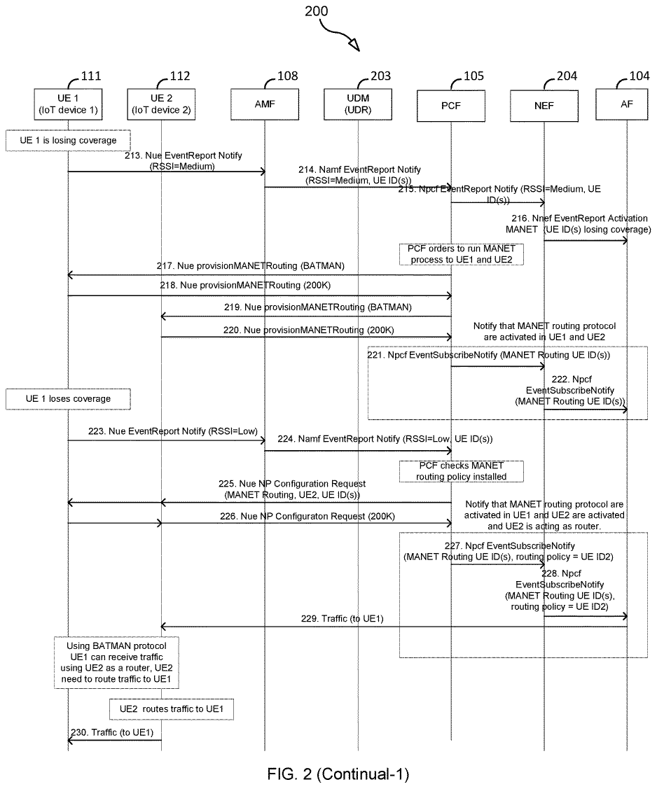

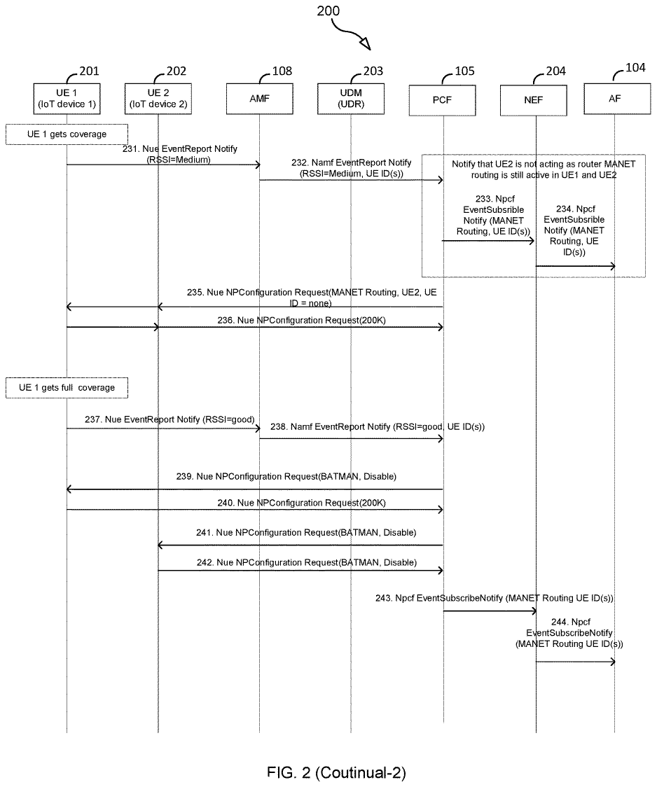

FIG. 2 is a message flow diagram illustrating a routing collaboration using MANET according to some embodiments. Steps shown in FIG. 2 are described below.

### Part 1, Subscription

201. An AF 104 (in some embodiments, it could be the owner of devices, or in some cases related to mining industry, it might be a miner owner) decides to indicate Mobile Network Operator, MNO, (i.e., NEF 102) to provide MANET routing for a set of users, it sends a Nnef Event Subscribe Request message to NEF 102, wherein the message comprises information indicating MANET Routing. The message also comprises a plurality of UE IDs indicating subscription the radio condition information related to the plurality of UEs. The message also comprises information indicating MANET routing policy which defines with type of MANET routing policy should be done, for example, one specific UE should be router for rest of the traffic or if it should be handled randomly.

202. Optionally, the NEF 102 sends the request the UDR/UDM 203 via Nudr Provisional Request with the information of MANET Routing, list of UE ID, MANET routing policy.

203. Optionally, the UDR/UDM 203 stores the information and confirms the request to NEF 102 via a Nudr Provisional Response message.

Both 202 and 203 are optional steps. This is good to keep track those MANET related information over UDR/UDM 203. So, in case other content provider wants to send traffic to the UEs or receives traffic from the UE, they can know that the UEs are going to have MANET routing.

204. The NEF 102 sends the request to PCF 105 via a Npcf Event Subscribe Request message comprising the MANET Routing information, list of UE ID, routing policy information. Alternatively, PCF 105 may also receive the information by interacting with UDR/UDM 203.

205. The PCF 105 sends Namf Event Subscribe Request message to an AMF 108 to subscribe the radio condition of the UEs. The message comprises a list UE IDs to indicate subscription radio condition of the UEs identified by the UE IDs. The message also comprises information related to UE reachability and RSSI [range].

In 3GPP standards (3GPP TS 29.518 V17.5.0) there is an event that defines if a UE is reachable, but it is not telling when it is going to become unreachable.

| | | | | |
|---|---|---|---|---|
| reachability | Ue Reachability | O | 0 . . . 1 | Describes the reachability of the UE |

| Enumeration value | Description |
|---|---|
| “UNREACHABLE” | Indicates the UE is not reachable, e.g., when the Mobile Reachable |
| | Timer in AMF expires. |
| “REACHABLE” | Indicates the UE is reachable for services and downlink traffic. |
| “REGULATORY_ONLY” | Indicates the UE is reachable only for Regulatory Prioritized Service as |
| | the UE is in Not Allowed Areas. |

It is proposed in the present disclosure a new flag (i.e., RSSI [range]) indicating that the AMF 108 shall ask the UEs for the RSSI information.

Information Element: RSSI including a set of conditions to indicate the radio condition of the UEs, as an example, it might be

| RF condition | RSSI |
|---|---|
| Good | Up to −75 dBm |
| Medium | −75 dBm to −90 dBm |
| Bad/Low | Less than −90 dBm |

Those conditions values are examples, and more conditions can be defined.

206, and 208. The AMF 108 sends a new request to the list of UEs (i.e., UE 111 and UE 112) to subscribe information about RSSI. In example above, when RSSI value of a UE in the range of −75 dBm to −90 dBm indicates that the UE is in medium radio condition. When RSSI value of the UE more than −75 dBm indicates that the UE is in good radio condition.

When RSSI value of the UE less than −90 dBm indicates that the UE is in low radio condition. In this situation, the UE can understand that radio condition changes, i.e., from good radio condition to medium radio condition, or from medium radio condition to low radio condition, etc.

207 and 209. The UEs (UE 111 and UE 112 answers to request of 206 and 208.

210. The AMF 108 answers back to the PCF 105; 211. The PCF 105 answers back to the NEF 102; 212. The NEF 102 answers back to the AF 104.

### Part 2, Losing Cellular Coverage

213, when the radio condition of UE 111 is under medium radio condition from good condition, that means the UE 111 is losing cellular coverage. The UE 111 sends a Nue EventReport Notify (RSSI=Medium) message towards the AMF 108 to report that the UE 111 is losing cellular coverage.

214. The AMF 108 reports back to the PCF 105 the UE(s) that are under medium radio conditions from good radio condition (losing coverage) via a Namf EventReport Notify (RSSI=Medium, UE ID(s) message.

215. The PCF 105 reports back to the NEF 102 the UE(s) that are under medium radio condition from good radio condition (losing coverage).

216. The NEF 102 reports back to the AF 104 the UE(s) that are under medium radio condition from good radio condition (losing coverage).

217-220. The PCF 105 orders to UE 111 (and also other UEs which lose cellular coverage) and UE 112 to activate MANET routing protocol (i.e., BATMAN). 217 and 219, the PCF 105 sends Nue provision MANET Routing (BATMAN) message to UE 111 and UE2 112 to indicate that UE 111 and UE 112 activate the MANET routing protocol (i.e., BATMAN). 218 and 220, the UE 111 and UE 112 send back answering towards the PCF 105. This process is going to be executed once one UE is under medium radio conditions from good radio condition.

221. The PCF 105 sends Npcf EventSubscribeNotify (MANET Routing UE ID(s)) to NEF 102 and 222. The NEF 102 Npcf EventSubscribeNotify (MANET Routing UE ID(s)) to the AF 104 to notify that the UE 111 and UE 112 have activated the MANET routing protocol (i.e., BATMAN).

### Part 3, Loses Cellular Coverage

223, when the radio condition of UE 111 is under low radio condition, that means the UE 111 loses cellular coverage. The UE 111 sends a Nue EventReport Notify (RSSI=Low) message towards the AMF 108 to report that the UE 111 loses cellular coverage.

224, the AMF 108 reports back to the PCF 105 the UE(s) that are under low radio conditions (loses coverage) via a Namf EventReport Notify (RSSI=Low, UE ID(s) message.

225, the PCF 105 checks the MANET routing policy for selecting which UE should be as MANET router for rest. In this particular case, it is selected directly UE 112. Other possible policies: select randomly one UE with coverage. The PCF 105 sends, to the UE 112, a message Nue NP Configuration Request (MANET Routing, UE ID2, UE ID(s) indicating that UE 112 is going to behave as router for traffic towards to UE 111 or the traffic toward UE 111.

226, the UE 112 answers positively back to the PCF 105.

227-228, the PCF 105 Notify for the AF 104 via NEF 102 that MANET routing protocol are activated in UE 111 and UE 112, and UE 112 is acting as router for the traffic towards/from the UE 111.

229-230, the UE 111 receives traffic from the AF 104 using UE 112 as router by using MANET protocol (i.e., BATMAN). 229, the AF 104 sends traffic (to UE 111) towards the UE 112; and the UE 112 routes the traffic to UE 111 via 230.

When connection between UE 112 and UE 111 is established using MANET protocol (i.e., BATMAN), and UE 111 may send uplink traffic towards UE 112 which is going to route towards AF 104.

### Part 4, Getting Cellular Coverage

231, when the radio condition of UE 111 is under medium radio condition from low condition, that means the UE 111 is getting cellular coverage. The UE 111 sends a Nue EventReport Notify (RSSI=Medium) message towards the AMF 108 to report that the UE 111 is getting cellular coverage.

232, the AMF 108 reports back to the PCF 105 the UE(s) that are under medium radio conditions from low radio condition (getting coverage) via a Namf EventReport Notify (RSSI=Medium, UE ID(s) message.

233, the PCF 105 reports back to the NEF 102 the UE(s) that are under medium radio condition from low radio condition (getting coverage).

234, the NEF 102 reports back to the AF 104 the UE(s) that are under medium radio condition from low radio condition (getting coverage).

235, the PCF 105 sends Nue NPConfiguration Request (MANET Routing, UE, UE ID=none) to UE 111 and UE 112 to indicate that UE 2 is not to act as MANET router for the UE 111. 236, the UE 2 111 sends answering back to the PCF 105. And the UE 111 deactivates MANET routing.

### Part 4, Get Full Coverage

237, when the radio condition of UE 111 is under good radio condition from medium condition, that means the UE 111 get full cellular coverage. The UE 111 sends a Nue EventReport Notify (RSSI=good) message towards the AMF 108 to report that the UE 111 get full cellular coverage.

238, the AMF 108 reports back to the PCF 105 the UE(s) that are under good radio conditions from medium radio condition (get full coverage) via a Namf EventReport Notify (RSSI=good, UE ID(s) message.

239, the PCF 105 sends Nue NPConfiguration Request (BATMAN, Disable) to UE 111 to indicate that UE 1 111 to inactivate MANET routing protocol (i.e., BATMAN). And 240, the UE 1 111 sends answering back to the PCF 105.

241, the PCF 105 sends Npcf EventSubscribeNotify (MANET Routing UE ID(s)) to UE 112 to indicate that UE 2 112 to inactivate MANET routing protocol (i.e., BATMAN). And 242, the UE 2 112 sends answering back to the PCF 105.

243, the PCF 105 sends Npcf EventSubscribeNotify (MANET Routing UE ID(s) to the NEF 102 and 244, the NEF 102 sends, towards the AF 104, Npcf EventSubscribeNotify (MANET Routing UE ID(s) message indicating that the UE 111 and the UE 112 have inactivated MANET routing protocol.

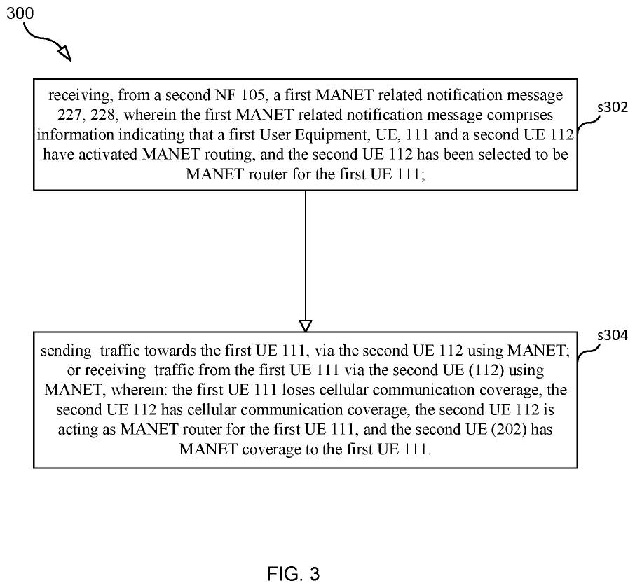

FIG. 3 is a flowchart illustrating a process 300, according to an embodiment, that is performed by a first network function (e.g., AF 104).

Step s302 comprises, receiving 302, from a second NF 105, a first MANET related notification message 227, 228, wherein the first MANET related notification message comprises information indicating that a first User Equipment, UE, 111 and a second UE 112 have activated MANET routing, and the second UE 112 has been selected to be MANET router for the first UE 111.

Step s304 comprises sending (s304) traffic towards the first UE 111 via the second UE 112 using MANET; or receiving (S304) traffic from the first UE 111 via the second UE (112) using MANET, wherein: the first UE 111 loses cellular communication coverage, the second UE 112 has cellular communication coverage, the second UE 112 is acting as MANET router for the first UE 111, and the second UE (112) has MANET coverage to the first UE 111.

In some embodiments, the first MANET related notification message is an Event subscribe Notify message (e.g. Npcf EventSubscribeNotify). In some embodiments, the UE might be Internet of Things (IoT) device.

In some embodiments, the first network function (e.g., AF 104) may send, towards the second NF (i.e. PCF 105), a MANET related subscription message, wherein the subscription message comprises a plurality of UE IDs indicating subscription the radio condition information related to the plurality of UEs identified by the plurality of UE IDs. In some embodiments, the MANET related subscription message is an Event subscribe message (e.g. Nnef Event Subscribe Request).

In some embodiments, the MANET related subscription message may comprise information indicating MANET routing policy. In some embodiments, the MANET routing policy may be: selecting a specific UE from the plurality of UEs as the MANET router, or randomly selecting a UE from the plurality of UEs as the MANET router UE.

In some embodiments, the first NF (i.e. AF 104) may receive from a second NF (e.g., PCF 105) a second MANET related notification message, wherein second MANET related notification message may comprise information indicating that one of: the first UE 111 and the second UE 112 have activated MANET process, the second UE 112 has deactivated MANET routing for the first UE 111, and the first UE 111 and the second UE 112 have deactivated MANET process. In some embodiments, the MANET may be Flying Ad Hoc Network, FANET, or Vehicular Ad hoc Network, VANET.

In some embodiments, the MANET uses MANET routing protocol, and the MANET routing protocol may be one of: proactive protocol (i.e., Better Approach To Mobile Adhoc Networking, BATMAN), reactive protocol (i.e., Dynamic Source Routing, DSR), and hybrid protocols (i.e., Order One Routing Protocol, OORP).

In some embodiments, the first NF (i.e. AF 104 may send subscription message via Network Exposure Function, NEF 102, towards Unified Data Repository, UDR, or Unified Data Management, UDM (203); and the second NF (i.e. PCF 105) may request the subscription information from the UDR/UDM (203).

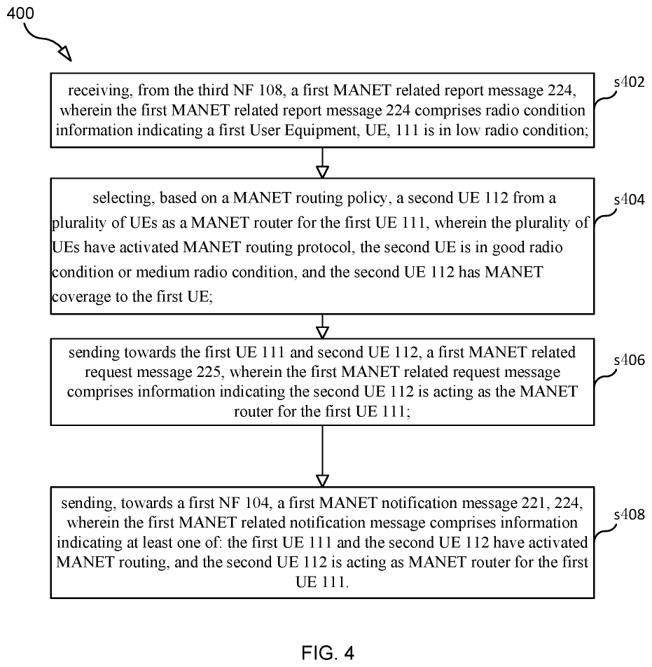

FIG. 4 is a flowchart illustrating a process 400, according to an embodiment, that is performed by a second network function (e.g., PCF 105). The process may begin in s402.

Step s402 comprises receiving, from the third NF 108, a first MANET related report message 224, wherein the first MANET related report message 224 comprises radio condition information indicating a first User Equipment, UE, 111 is in low radio condition.

Step 404 comprises selecting, based on a MANET routing policy, a second UE 112 from a plurality of UEs as a MANET router for the first UE 111, wherein the plurality of UEs have activated MANET routing protocol, the second UE is in good radio condition or medium radio condition, and the second UE 112 has MANET coverage to the first UE.

Step 406 comprises sending, towards the first UE 111 and second UE 112, a first MANET related request message 225, wherein the first MANET related request message comprises information indicating the second UE 112 is acting as the MANET router for the first UE 111.

Step 408 comprises sending (s408), towards a first NF 104, a first MANET notification message 221, 224, wherein the first MANET related notification message comprises information indicating at least one of: the first UE 111 and the second UE 112 have activated MANET routing, and the second UE 112 is acting as MANET router for the first UE 111.

In some embodiments, the first MANET related report message is an Event Report Notify message (i.e. Namf EventReport Notify). In some embodiments, the first MANET related request message is a configuration request message (i.e., Nue NP Configuration Request). In some embodiments, the first MANET related request message may be sent to the second UE 112 via the third NF (i.e., AMF 108). In some embodiments, the first MANET related notification message may be an Event Subscribe Notify message (i.e., Npcf EventSubscribeNotify).

In some embodiments, the MANET routing policy may comprise selecting a specific UE from the plurality of UEs as the MANET router, or randomly selecting a UE from the plurality of UEs as the MANET router UE.

In some embodiments, the second NF (i.e., PCF 105 may receive, from a third NF (i.e., AMF 108), a previous MANET related report message (i.e., 214, Namf EventReport Notify (RSSI=Medium, UE ID(s))), wherein the previous MANET related report message comprises radio condition information indicating the first UE 111 is in medium radio condition from good radio condition.

In some embodiments, in response to receiving the previous MANET related report message, the second NF (i.e., PCF 105 may send, towards the first NF (i.e., AF 104), a previous MANET related notification message (i.e., 215, Npcf EventReport Notify (RSSI=Medium, UE ID(s) and 216, Nnef EventReport Activation MANET (UE ID(s) losing coverage)), wherein the previous MANET related notification message comprises information indicating the first UE 111 has activated MANET process

In some embodiments, the second NF (i.e., PCF 105 may send a previous MANET related request message (i.e., 217 and 219, Nue provisionMANETRouting (BATMAN) to a plurality of UEs (111, 112), wherein the previous MANET related request message comprises information (i.e., MANET routing) indicating the plurality of UEs to activate MANET process.

In some embodiments, the second NF (i.e., PCF 105 may receive, from a third NF (i.e., AMF 108), a second MANET related report message (i.e., 232, Namf EventReport Notify (RSSI=Medium, UE ID(s))), wherein the second MANET related report message comprises radio condition information indicating the first UE 111 is in medium radio condition from low radio condition.

In some embodiments, in response to receiving the second MANET related report message, the second NF (i.e., PCF 105 may send, towards the first NF (i.e., AF 104), a second MANET related notification message (i.e., 233, Npcf EventSubsrible Notify (MANET Routing, UE ID(s) and 234, Npcf EventSubsrible Notify (MANET Routing, UE ID(s))), wherein the second MANET related notification message comprises information indicating the second UE 112 has inactivated MANET routing for the first UE 111.

In some embodiments, the second NF (i.e., PCF 105 may send a second MANET related request message (i.e., 235, Nue NPConfiguration Request (MANET Routing, UE, UE ID=none))) to the second UE 112, wherein the second MANET related request message comprises information (i.e., MANET routing) indicating the second UE 112 to deactivate MANET routing for the first UE 111.

In some embodiments, the second NF (i.e., PCF 105 may receive, from a third NF (i.e., AMF 108), a third MANET related report message (i.e., 238, Namf EventReport Notify (RSSI=good, UE ID(s))), wherein the third MANET related report message comprises radio condition information indicating the first UE 111 is in good radio condition from medium radio condition.

In some embodiments, in response to receiving the second MANET related report message, the second NF (i.e., PCF 105 may send, towards the first NF (i.e., AF 104), a third MANET related notification message (i.e., 243, Npcf EventSubsrible Notify (MANET Routing, UE ID(s) and 244, Npcf EventSubsrible Notify (MANET Routing, UE ID(s))), wherein the third MANET related notification message comprises information indicating the first UE 111 and the second UE 112 have inactivated MANET protocol.

In some embodiments, the second NF (i.e., PCF 105 may send a third MANET related request message (i.e., 239 and 41, Nue NPConfiguration Request (MANET Routing, UE, UE ID=none))) to the first UE 111 and the second UE 112, wherein the third MANET related request message comprises information (i.e., MANET routing) indicating the first UE 111 and the second UE 112 have inactivated MANET protocol.

In some embodiments, the second NF (e.g. PCF 105 may receive, from the first NF (i.e. AF 104), a MANET related subscription message, wherein the subscription message comprises a plurality of UE IDs indicating subscription the radio condition information related to the plurality of UEs identified by the plurality of UE IDs. In some embodiments, the MANET related subscription message is an Event subscribe message (e.g. Nnef Event Subscribe Request, refer to 201 and 202).

In some embodiments, the second NF (e.g. PCF 105) may send, towards the third NF (i.e. AMF 108), a MANET related subscription message, wherein the subscription message comprises a plurality of UE IDs indicating subscription the radio condition information related to the plurality of UEs identified by the plurality of UE IDs. In some embodiments, the MANET related subscription message is an Event subscribe message (e.g. 5. Namf Event Subscribe Request (UE reachability (RSSI [range]), list of UE ID, . . . ), refer to 205).

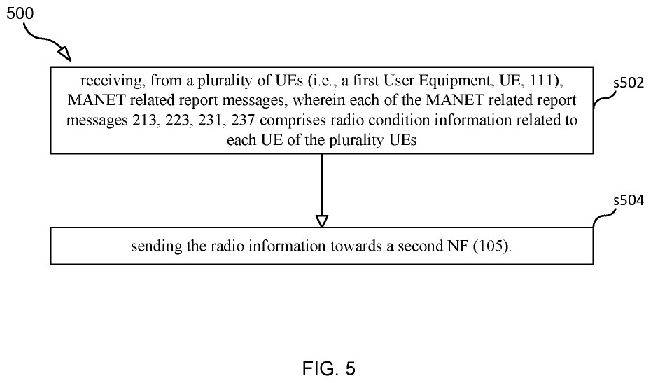

FIG. 5 is a flowchart illustrating a process 500, according to an embodiment, that is performed by a third network function (e.g., AMF 108). The process may begin in s502.

Step s502 comprises receiving, from a plurality of User Equipments, UEs, (i.e., a first UE 111), MANET related report messages, wherein each of the MANET related report messages 213, 223, 231, 237 comprises radio condition information related to each UE of the plurality UEs.

Step 504 comprises sending the radio information towards a second NF 105 (e.g., the PCF (104)).

In some embodiments, the third NF (e.g., AMF 108) may receive, from the second NF (e.g. PCF 105), a MANET related subscription request message, wherein the MANET related subscription request message comprises a plurality of UE IDs indicating subscription the radio condition information related to the plurality of UEs identified by the plurality of UE IDs; and in some embodiments, the third NF (e.g., AMF 108) send a MANET related subscription request message to the plurality of UE to subscribe the radio condition information.

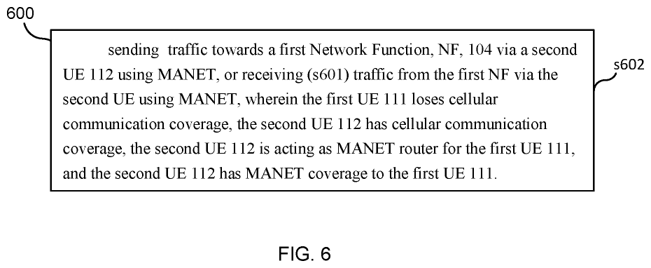

FIG. 6 is a flowchart illustrating a process 600, according to an embodiment, that is performed by a UE (e.g., first UE 111. The process may begin in s602.

Step s602 comprises sending traffic towards a first Network Function, NF, 104 via a second UE 112 using MANET, or receiving (s601) traffic from the first NF via the second UE using MANET, wherein the first UE 111 loses cellular communication coverage, the second UE 112 has cellular communication coverage, the second UE 112 is acting as MANET router for the first UE 111, and the second UE 112 has MANET coverage to the first UE 111.

In some embodiments, in some embodiments, the first UE 111 may receive from the third NF (e.g., AMF 108) a MANET related subscription request message to subscribe the radio condition information.

In some embodiments, the first UE 111 may send, towards a third NF (e.g., AMF 108) a first MANET related report message, wherein the first MANET report message comprises information indicating that the first UE 111 is in low radio condition from medium radio condition. In response to the reporting the first UE 111 is in low radio condition from medium radio condition, receiving a first MANET related request message, wherein the first MANET related request message comprises information (i.e., MANET routing) indicating the first UE 111 to activate MANET routing.

In some embodiments, the first UE 111 may send, towards a third NF a second MANET related report message, wherein the second MANET report message comprises information indicating that the first UE is in medium radio condition from good radio condition. In response to the reporting the first UE is in medium radio condition from good radio condition, the first UE 111 may receive a second MANET related request message, wherein the second MANET related request message comprises information (i.e., MANET routing) indicating the first UE to activate MANET process.

In some embodiments, the first UE 111 may send, towards a third NF a third MANET related report message, wherein the third MANET report message comprises information indicating that the first UE 111 is in medium radio condition from low radio condition. In response to the reporting the first UE is in medium radio condition from low radio condition, the first UE 111 may receive a third MANET related request message, wherein the third MANET related request message comprises information (i.e., MANET routing) indicating the first UE to deactivate MANET routing.

In some embodiments, the first UE 111 may send, towards a third NF a fourth MANET related report message, wherein the fourth MANET report message comprises information indicating that the first UE 111 is in good radio condition from medium radio condition. In response to the reporting the first UE is in good radio condition from medium radio condition, the first UE 111 may receive a fourth MANET related request message, wherein the fourth MANET related request message comprises information (i.e., MANET routing) indicating the first UE to deactivate MANET protocol.

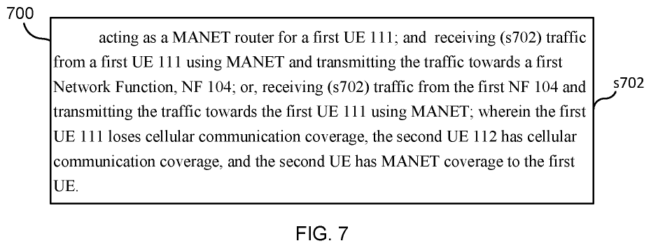

FIG. 7 is a flowchart illustrating a process 700, according to an embodiment, that is performed by a UE (e.g., a second UE 112).

Step s602 comprises acting as a MANET router for a first UE 111; and receiving (s702) traffic from a first UE 111 using MANET and transmitting the traffic towards a first Network Function, NF 104; or, receiving (s702) traffic from the first NF 104 and transmitting the traffic towards the first UE 111 using MANET; wherein the first UE 111 loses cellular communication coverage, the second UE 112 has cellular communication coverage, and the second UE has MANET coverage to the first UE.

In some embodiments, the second UE 112 may receive a first MANET related request message when the first UE is in low radio condition from medium radio condition, wherein the first MANET related request message comprises information (i.e., MANET routing) indicating the second UE to activate MANET routing.

In some embodiments, the second UE 112 receive a second MANET related request message when the first UE is in medium radio condition from good radio condition, wherein the second MANET related request message comprises information (i.e., MANET routing) indicating the second UE to activate MANET process.

In some embodiments, the second UE 112 may receive a third MANET related request message when the first UE is in medium radio condition from low radio condition, wherein the second MANET related request message comprises information (i.e., MANET routing) indicating the second UE to deactivate MANET routing.

In some embodiments, the second UE 112 may receive a fourth MANET related request message when the first UE is in good radio condition from medium radio condition, wherein the second MANET related request message comprises information (i.e., MANET routing) indicating the second UE to deactivate MANET process.

In the process 400, 500, 600, 700 and 800, in some embodiments, the radio condition information may be Received Signal Strength Indicator, RSSI, value of RSSI indicates the UE is in medium radio condition, low medium radio condition or good radio condition.

In some embodiments, the UE is in low radio condition indicates the UE lost cellular communication coverage; and that the UE is entering in medium radio condition from good radio condition indicates the UE is losing cellular communication coverage; and the UE is in good radio condition indicates the UE has cellular communication coverage.

In some embodiments, the value of RSSI of a UE greater than −75 dBm may indicate the UE is in good radio condition; the value of RSSI of a UE within −75 dBm and −90 dBm may indicate the UE is in medium radio condition; the value of RSSI of a UE less than −90 dBm may indicate the UE is in bad radio condition. Those conditions values are examples, and more conditions may be defined.

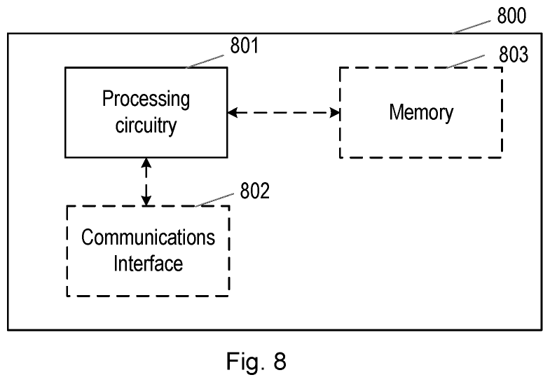

FIG. 8 is a simplified block diagram of a network node (or terminal device) 800 according to some embodiments that can be used to implement one or more of the techniques described herein. Any one of the network function and the terminal device described above may be implemented through the apparatus 800. In particular embodiments, the network node (or terminal device) 800 can be or implement any one or more of the NFs used in the 5G implementation of the techniques described herein, such as the AMF 108, UDM/UDR 203, PCF 105, NEF 102 and AF 104, UE 111, 112. In other embodiments, the network node 800 can be or implement any one or more of the functions used in the 4G implementation of the techniques described herein, such as the Mobility Management Entity (MME), Policy and Charging Rules Function (PCRF) and Application Server (AS), UE.

The network node 800 comprises processing circuitry (or logic) 801. It will be appreciated that the network node 800 may comprise one or more virtual machines running different software and/or processes. The network node 800 may therefore comprise, or be implemented in or as one or more servers, switches and/or storage devices and/or may comprise cloud computing infrastructure that runs the software and/or processes.

The processing circuitry 801 controls the operation of the network node 800 to implement the relevant part of the methods described herein. The processing circuitry 801 can comprise one or more processors, processing units, multi-core processors or modules that are configured or programmed to control the network node 800 in the manner described herein. In particular implementations, the processing circuitry 801 can comprise a plurality of software and/or hardware modules that are each configured to perform, or are for performing, individual or multiple steps of the method described herein in relation to the network node 800.

The network node 800 also comprises a communications interface 802. The communications interface 802 is for use in enabling communications with other network node, computers, servers, etc. For example, the communications interface 802 can be configured to transmit to and/or receive from other network nodes requests, acknowledgements, information, data, signals, or similar. The communications interface 802 can use any suitable communication technology.

The processing circuitry 801 may be configured to control the communications interface 802 to transmit to and/or receive from other network nodes, etc. requests, acknowledgements, information, data, signals, or similar, according to the methods described herein.

The network node 800 may comprise a memory 803. In some embodiments, the memory 803 can be configured to store program code that can be executed by the processing circuitry 801 to perform the method described herein in relation to the network node 800. Alternatively or in addition, the memory 803 can be configured to store any requests, acknowledgements, information, data, signals, or similar that are described herein. The processing circuitry 801 may be configured to control the memory 803 to store such information therein.

Although the network node may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

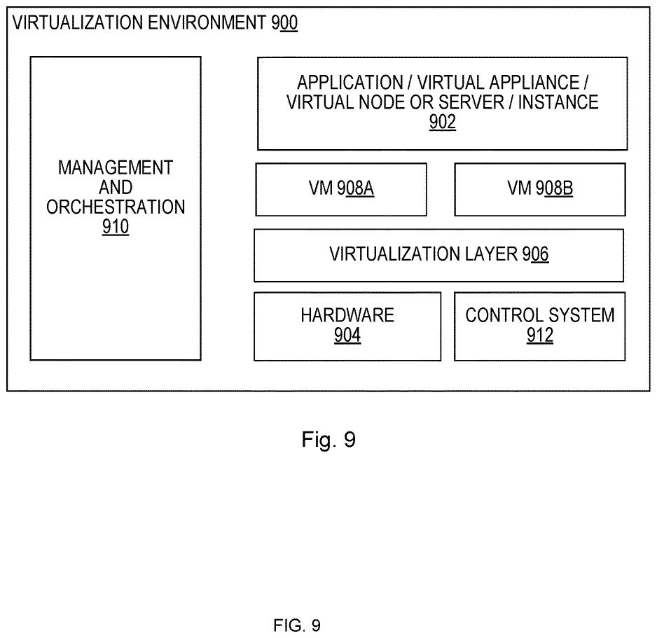

FIG. 9 is a block diagram illustrating a virtualization environment 900 in which functions implemented by some embodiments may be virtualized.

In the present context, virtualizing means creating virtual versions of network nodes which may include virtualizing hardware platforms, storage devices and networking resources. As used herein, virtualization can be applied to any network node described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as a network node. Further, the network node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art. While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network function (NF) for Mobile Ad-Hoc Networks (MANET) routing, the method comprising:
receiving, from a second NF, a first MANET related notification message, wherein the first MANET related notification message comprises information indicating that a first User Equipment (UE) and a second UE have activated MANET routing, and the second UE has been selected to be MANET router for the first UE;
sending traffic towards the first UE, via the second UE using MANET; or receiving traffic from the first UE via the second UE using MANET, wherein: the first UE loses cellular communication coverage, the second UE has cellular communication coverage, the second UE is acting as MANET router for the first UE, and the second UE has MANET coverage to the first UE.

2. The method of claim 1, further comprising sending, towards the second NF, a MANET related subscription message, wherein:
the subscription message comprises a plurality of UE Identifiers (IDs) indicating subscription the radio condition information related to a plurality of UEs identified by the plurality of UE IDs,
the MANET related subscription message furtherly comprises information indicating MANET routing policy, and/or
the MANET routing policy comprises selecting a specific UE from the plurality of UEs as the MANET router, or randomly selecting a UE from the plurality of UEs as the MANET router UE.

3-4. (canceled)

5. The method of claim 1, further comprising: receiving, from the second NF, a second MANET related notification message, wherein the second MANET related notification message comprises information indicating one of:
the first UE and the second UE have activated MANET routing protocol;
the second UE have deactivated MANET routing for the first UE; and
the first UE and the second UE have deactivated MANET routing protocol.

6. The method of claim 1, wherein
the MANET is Flying Ad Hoc Network (FANET) or Vehicular Ad hoc Network (VANET),
the first NF is Application Function (AF), and/or the second NF is Policy Control Function (PCF), and/or
the MANET routing protocol is one of:
proactive protocol,
reactive protocol, and
hybrid protocols.

7. (canceled)

8. The method of claim 1, wherein the first NF sends subscription message via Network Exposure Function (NEF) towards the second NF; and optionally, the first NF sends subscription message via the NEF towards a Unified Data Repository (UDR) or Unified Data Management (UDM) and the second NF requests the subscription information from the UDR/UDM.

9. (canceled)

10. A method performed by a second network function (NF) for Mobile Ad-Hoc Networks (MANET) routing, the method comprising:
receiving, from the third NF, a first MANET related report message, wherein the first MANET related report message comprises radio condition information indicating a first User Equipment (UE) is in low radio condition;
selecting, based on a MANET routing policy, a second UE from a plurality of UEs as a MANET router for the first UE, wherein the plurality of UEs have activated MANET routing protocol, the second UE is in good radio condition or medium radio condition, and the second UE has MANET coverage to the first UE;
sending, towards the first UE and second UE, a first MANET related request message, wherein the first MANET related request message comprises information indicating the second UE is acting as the MANET router for the first UE;
sending, towards a first NF, a first MANET notification message, wherein the first MANET related notification message comprises information indicating at least one of: the first UE and the second UE have activated MANET routing, and the second UE is acting as MANET router for the first UE.

11. The method of claim 10, wherein the MANET routing policy comprises: selecting a specific UE from the plurality of UEs as the MANET router, or randomly selecting a UE from the plurality of UEs as the MANET router.

12. The method of claim 10, further comprising:
receiving, from a third NF, a previous MANET related report message, wherein the previous MANET related report message comprises radio condition information indicating the first user UE is in medium radio condition from good radio condition;
in response to receiving the previous MANET related report message, sending, towards the first NF, a previous MANET related notification message, wherein the previous MANET related notification message comprises information indicating the first UE has activated MANET routing protocol; and,
sending a previous MANET related request message to a plurality of UEs, wherein the previous MANET related request message comprises information indicating the plurality of UEs to activate MANET routing protocol.

13. The method of claim 10, further comprising:
receiving, from the third NF, a second MANET related report message, wherein the second MANET related report message comprises radio condition information indicating the first UE is in medium radio condition from low radio condition;
in response to receiving the previous MANET related report message, sending a second MANET notification message to the first NF, wherein the second MANET notification message comprises information indicating the second UE has inactivated MANET routing for the first UE;
sending, towards the first UE and the second UE, a second MANET related request message, wherein the second MANET related request message comprises information indicating that the second UE deactivates MANET routing for the first UE.

14. The method of claim 10, further comprising:
receiving, from the third NF, a third MANET related report message, wherein the third MANET related report message comprises radio condition information indicating the first UE is in good radio condition from medium radio condition;
sending, towards the first UE and the second UE, a third MANET related request message, wherein the third MANET related request message comprises information indicating the first UE and the second UE to inactivate MANET routing protocol; and
sending a third MANET notification message to the first NF, wherein the third MANET notification message comprises information indicating the first UE and the second UE have inactivated MANET routing protocol.

15. The method of claim 10, further comprising:
receiving from, from the first NF, a MANET related subscription message, wherein the subscription message comprises a plurality of UE IDs indicating subscription the radio condition information related to the plurality of UEs identified by the plurality of UE IDs;
sending, towards to a third NF, a MANET related subscription request message, wherein the MANET related subscription request message comprises the plurality of UE IDs indicating subscription the radio condition information related to the plurality of UEs identified by the plurality of UE IDs.

16. The method of claim 10, further comprising:
the radio condition information is Received Signal Strength Indicator (RSSI) value of RSSI indicates the UE is in low radio condition, medium radio condition or good radio condition,
the UE in low radio condition indicates that the UE loses cellular communication coverage; the UE in medium radio condition from good radio condition indicates that the UE is losing cellular communication coverage; and the UE in good radio condition indicates the UE has cellular communication coverage, and/or
the value of RSSI of a UE greater than −75 dBm indicates the UE is in good radio condition; the value of RSSI of a UE within −75 dBm and −90 dBm indicates the UE is in medium radio condition; the value of RSSI of a UE less than −90 dBm indicates the UE is in low radio condition.

17-24. (canceled)

25. A method performed by a first User Equipment (UE) for Mobile Ad-Hoc Networks (MANET) routing, the method comprising:
sending traffic towards a first Network Function (NF) via a second UE using MANET, or receiving traffic from the first NF via the second UE using MANET, wherein the first UE loses cellular communication coverage, the second UE has cellular communication coverage, the second UE is acting as MANET router for the first UE, and the second UE has MANET coverage to the first UE.

26. The method of claim 25, further comprising:
sending, towards a third NF, a first MANET related report message, wherein the first MANET report message comprises information indicating that the first UE is in low radio condition;
in response to the reporting that the first UE is in low radio condition, receiving a first MANET related request message, wherein the first MANET related request message comprises information indicating the first UE to activate MANET routing and the second UE is acting as MANET router for the first UE,
sending, towards the third NF, a second MANET related report message, wherein the second MANET report message comprises information indicating that the first UE is in medium radio condition from good radio condition; and/or
in response to the reporting that the first UE is in medium radio condition from good radio condition, receiving a second MANET related request message, wherein the second MANET related request message comprises information indicating the first UE to activate MANET routing protocol.

27. (canceled)

28. The method of claim 25, further comprising:
sending, towards a third NF, a third MANET related report message, wherein the third MANET report message comprises information indicating that the first UE is in medium radio condition from low radio condition;
in response to the reporting that the first UE is in medium radio condition from low radio condition, receiving a third MANET related request message, wherein the third MANET related request message comprises information indicating the first UE to deactivate MANET routing and the second UE is not acting as MANET router for the first UE,
sending, towards the third NF, a fourth MANET related report message, wherein the fourth MANET report message comprises information indicating that the first UE is in good radio condition from medium radio condition; and/or
in response to the reporting that the first UE is in good radio condition from medium radio condition, receiving a fourth MANET related request message, wherein the fourth MANET related request message comprises information indicating the first UE to deactivate MANET routing protocol.

29. (canceled)

30. The method of claim 25, further comprising:
the radio condition information is Received Signal Strength Indicator (RSSI) value of RSSI indicates the UE is in medium radio condition, low medium radio condition or good radio condition;
the UE in low radio condition indicates that the UE loses cellular communication coverage; and the UE in medium radio condition from good radio condition indicates that the UE is losing cellular communication coverage; and the UE in good radio condition indicates the UE has cellular communication coverage,
the value of RSSI of a UE greater than −75 dBm indicates the UE is in good radio condition; the value of RSSI of a UE within −75 dBm and −90 dBm indicates the UE is in medium radio condition; and the value of RSSI of a UE less than −90 dBm indicates the UE is in bad radio condition, and/or
receiving a MANET related subscription request message indicating to report the radio condition information.

31-33. (canceled)

34. A method (700) performed by a second User Equipment (UE) for Mobile Ad-Hoc Networks (MANET) routing, the method comprising:
acting as a MANET router for a first UE; and,
receiving traffic from a first UE using MANET and transmitting the traffic towards a first Network Function (NF); or, receiving traffic from the first NF and transmitting the traffic towards the first UE using MANET; wherein the first UE loses cellular communication coverage, the second UE has cellular communication coverage, and the second UE has MANET coverage to the first UE.

35. The method of claim 34, further comprising:
receiving a first MANET related request message when the first UE is in low radio condition, wherein the first MANET related request message comprises information indicating that the second UE activate MANET routing, and the second UE is acting as MANET router for the first UE, and/or
receiving a second MANET related request message when the first UE is in medium radio condition from good radio condition, wherein the second MANET related request message comprises information indicating the second UE activate MANET routing protocol.

36. (canceled)

37. The method of claim 34, further comprising:
receiving a third MANET related request message when the first UE is in medium radio condition from low radio condition, wherein the second MANET related request message comprises information indicating the second UE is not acting as MANET router for the first UE, and optionally, the second UE to deactivate MANET routing, and/or
receiving a fourth MANET related request message when the first UE is in good radio condition, wherein the second MANET related request message comprises information indicating the second UE to deactivate MANET process.

38. (canceled)

39. The method of claim 34, further comprising:
the radio condition information is Received Signal Strength Indicator (RSSI) value of RSSI indicates the UE is in medium radio condition, low medium radio condition or good radio condition,
the UE in low radio condition indicates that the UE losses cellular communication coverage; and that the UE in medium radio condition from good radio condition indicates that the UE is losing cellular communication coverage; and the UE in good radio condition indicates the UE has cellular communication coverage,
the value of RSSI of a UE greater than −75 dBm indicates the UE is in good radio condition; the value of RSSI of a UE within −75 dBm and −90 dBm indicates the UE is in medium radio condition; and the value of RSSI of a UE less than −90 dBm indicates the UE is in bad radio condition, and/or
receiving a MANET related subscription request message indicating to report the radio condition information.

40-45. (canceled)
